(19) United States
(12) Patent Application Publication
(10) Pub. No.: US 2010/0213881 A1
(43) Pub. Date: Aug. 26, 2010

(54) Light source apparatus

(75) Inventor: Yuji Imai, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/656,952

(22) Filed: Feb. 22, 2010

(30) Foreign Application Priority Data
Feb. 23, 2009 (JP) 2009-039463

(51) Int. Cl. H01J 1/62; H05B 37/00

(52) U.S. Cl. 315/363; 313/502

(57) ABSTRACT

A light source apparatus that includes a light emitting diode and a fluorescent material film. The fluorescent material film converts ultraviolet or blue light emitted from the light emitting diode into white light. The film is formed by coating, on at least one side of a glass substrate, a liquid mixture of fluorescent material, an organic binder, and a solvent, followed by drying and firing, and another thin film is further formed by coating, on the fluorescent material film, a coating material that contains a metallic alkoxide and/or metallic alkoxide oligomer, followed by drying and firing.

### CROSS-REFERENCES TO RELATED APPLICATION

This application claims priority from Japanese Patent Application Serial No. 2009-039463 filed Feb. 23, 2009, the contents of which are incorporated herein by reference in its entirety

### TECHNICAL FIELD

The present invention generally relates to a light source apparatus, which converts blue light emitted from a light diode, into white light by a fluorescent material. The present invention relates to a light source apparatus, which has excellent moisture resistance, heat resistance, and durability, having improved luminous efficacy when the light emitted from the light diode is converted into white light by a fluorescent material.

### BACKGROUND

In the conventional light source apparatus, blue light emitted from the light emitting diode is converted into white light when passing through a YAG-based fluorescent material film. The conventionally used fluorescent material film is, for example, made of garnet doped with rare-earth elements (e.g., Y₃Ga₅O₁₂:Ce³⁺, Y(Al, Ga)₅O₁₂:Ce³⁺, Y(Al, Ga)₅O₁₂:Tb³⁺); alkaline-earth sulfides doped with rare-earth elements (e.g., SrS:Ce³⁺, Na, SrS:Ce³⁺, Cl, SrS:CeCl₃, CaS:Ce³⁺, SrSe:Ce³⁺); and thiogallate doped with rare-earth elements (e.g., CaGa₂S₄:Ce³⁺, SrGa₂S₄:Ce³⁺), as described in Japanese Patent Application Publication No. 2004-111981. Further, the fluorescent material film may be made of aluminate doped with rare-earth elements (e.g., YAlO₃:Ce³⁺, YGaO₃:Ce³⁺, Y(Al, Ga)O₃:Ce³⁺); orthosilicate doped with rare-earth elements (e.g., M₂SiO₅:Ce³⁺ (wherein M: Sc, Y, Sc), Y₂SiO₅:Ce³⁺) or the like.

### SUMMARY

Conventionally, the fluorescent material used for a light source apparatus in general is contained in a silicone resin sheet. It is difficult to bond or attach the silicone resin sheet containing the fluorescent material to a light source apparatus having parts in various shapes, especially the spherical surface part of electric bulb. That is, there are limitations in applying the silicone resin sheet containing fluorescent material to a light source apparatus having parts in various shapes. Moreover, conventional fluorescent materials have problems with moisture resistance, heat resistance, and durability in addition to luminous efficacy.

Because conventional fluorescent material films are vulnerable to high humidity and high temperature, and have problems with reliability and life span, they cannot be used in a high-output light source apparatus, or particularly in a fishery etc. And although the silicone resin sheet containing a fluorescent material may address the humidity and temperature by covering the fluorescent material with the silicone resin film, the silicone resin still tends to absorb moisture, which does not solve the problem.

Also, when the silicone resin containing the fluorescent material becomes high in temperature due to the generation of heat in the light emitting diode, the luminous efficacy decreases, thereby deteriorating the property thereof. Moreover, when the light emitting diode is covered with the silicone resin, the quality thereof becomes worse due to the temperature rise caused by poor heat conduction. Furthermore, because the silicone resin containing the fluorescent material is generally in form of a sheet, it is difficult to apply the resin to the light source apparatus that has various spherical surfaces other than a plane.

In order to solve the above problems, an object of the present invention is to offer a light source apparatus capable of converting, into white light, blue light emitted from a light emitting diode with excellent luminous efficacy, moisture resistance, heat resistance, durability, and reliability. In addition, another object of the present invention is to offer a light source apparatus that applies to a light emission face that is not a plane, such as a spherical surface.

A light source apparatus according to a first embodiment of the invention comprises a light emitting diode and a fluorescent material film that converts ultraviolet or blue light emitted from the light emitting diode into white light, wherein the fluorescent material film is formed by coating, on at least one side of a glass substrate, a liquid mixture of fluorescent material, an organic binder, and a solvent, followed by drying and firing, and a thin film is further formed by coating, on the fluorescent material film, a coating material that contains a metallic alkoxide and/or metallic alkoxide oligomer, followed by drying and firing.

According to a second embodiment of the invention, in the above-mentioned light source apparatus, the metallic alkoxide may have, as a metal element, at least one metal selected from a group consisting of silicon, titanium, and zirconia.

According to a third embodiment of the invention, in the above-mentioned light source apparatus, the organic binder may be at least one selected from a group consisting of a cellulose group incuding methyl cellulose, etylcellulose, hydroxyethyl cellulose, a polyvinyl alcohol group resin, alkyd group resin, btyral group resin, phenol group resin, and rosin group resin.

A light source apparatus according to a fourth embodiment of the invention comprises a casing, which may at least be partially made of a glass substrate, a light emitting diode assembly attached to the inside of the casing, a fluorescent material film that may be formed by coating on at least one side of a glass substrate, a liquid mixture of fluorescent material, an organic binder, and a solvent, followed by drying and firing, and a thin film is further formed by coating, on the fluorescent material film, a coating material that contains a metallic alkoxide and/or metallic alkoxide oligomer, followed by drying and firing, and a power connection unit that may be electrically connected to the light emitting diode assembly and may be provided on the casing.

A light source apparatus according to a fifth embodiment of the invention comprises a casing, which may at least be partially made of a glass substrate in a light bulb shape, a light emitting diode assembly attached to the inside of the casing, a fluorescent material film that may be formed by coating on at least one side of a glass substrate, a liquid mixture of fluorescent material, an organic binder, and a solvent, followed by drying and firing, and a thin film is further formed by coating, on the fluorescent material film, a coating material that contains a metallic alkoxide and/or metallic alkoxide oligomer, followed by drying and firing, a power supply unit that supplies electric power to the light emitting diode assembly, and a socket that is electrically connected to the power supply unit.

According to a sixth embodiment of the invention, in the light source apparatus, the light emitting diode assembly may be suspended inside the casing or the light bulb-shaped translucent member by a member having electrical conduction and heat transfer.

According to a seventh embodiment of the invention, in the light source apparatus, the thickness of the fluorescent material film may be 20 to 200 μm (micrometer).

According to an eighth embodiment of the invention, in the light source apparatus, the socket portion may include an electric conduction screw portion, which is screwed in a lighting fixture, and a heat dissipation part.

In the light source apparatus according to a ninth embodiment of the invention, the glass substrate may be a lens having a convex and/or concave surface.

According to the present invention, two layers of light conversion material, namely, a fluorescent material film and a thin film formed by coating a coating material that contains a metallic alkoxide and/or metallic alkoxide oligomer, followed by drying and firing, are formed, which produce a light source apparatus with excellent luminance efficiency, moisture resistance, heat resistance, durability, and reliability.

According to the present invention, a fluorescent material film is formed by coating, on a glass substrate, a dispersion prepared by dispersing a composition containing metallic oxide fine particles and a yellow fluorescent material capable of absorbing part of the blue light thereby emitting yellow light, in a metallic alkoxide and/or metallic alkoxide oligomer, followed by firing, which produces a light source apparatus with excellent luminance efficiency, moisture resistance, heat resistance, durability, and reliability.

Since the fluorescent material film is formed by the two layers of light conversion material, it is possible to provide the film on a face having any shape, especially a light source apparatus such as a light bulb or a flashlight.

According to the present invention, a light source apparatus can suit the needs of tropical region use where the temperature is high, be attached to a tool with high temperature, or be use in a place where it tends to be exposed to water, while maintaining high luminance efficiency and durability.

### BRIEF DESCRIPTION OF DRAWINGS

FIG. 1A is an explanatory cross sectional view of a light source apparatus that includes an electric bulb-like transparent material according to Example 1 of the present invention;

FIG. 1B is an explanatory cross sectional view of another light source apparatus according to Example 1;

FIG. 2 is an explanatory view of a light emitting diode assembly according to an embodiment of the present invention;

FIG. 3 is an explanatory diagram showing a method of forming a fluorescent material film on an inner wall surface of a spherical surface, according to an embodiment of a present invention;

FIG. 4 is an explanatory diagram of a method of forming a fluorescent material film on an outer wall surface of a spherical surface according to another embodiment of the present invention;

FIG. 5 is a diagram for explaining the effect due to the existence of covered resin according to an embodiment, comparing an example of prior art that does not have covered resin;

FIG. 6 is a diagram for explaining transition of the temperature and luminous efficacy of the fluorescent material film according to the present invention and an example of prior art;

FIG. 7 is a diagram for explaining the relation between time and temperature in a light emission apparatus in which a fluorescent material film according to the present invention is used;

FIG. 8 is a diagram for explaining the peak of wavelength in a light emission apparatus in which a fluorescent material film according to the present invention is used; and

FIG. 9 is a diagram for explaining the peak of wavelength in a light emission apparatus in which a fluorescent material film of prior art is used.

### DESCRIPTION

### First Embodiment

A light source apparatus according to a first embodiment of the invention comprises at least a light emitting diode and a fluorescent material film capable of converting, for example, blue light with wavelength of 455 nm, which is emitted from the light emitting diode, into white light. The light conversion material to convert ultraviolet or blue light emitted from the light emitting diode into white light is formed by the fluorescent material film that is formed by coating, on at least one side of a glass substrate, a liquid mixture of fluorescent material, an organic binder, and a solvent, followed by drying and firing, and a thin film further formed by coating, on the fluorescent material film, a coating material that contains a metallic alkoxide and/or metallic alkoxide oligomer, followed by drying and firing. The glass substrate may have a flat surface, may include a concaved or convexed (lens) surface. Further the glass substrate may durable for the firing.

The fluorescent material film for converting light emitted from the light emitting diode into white light can also be obtained by coating a liquid prepared by dispersing spin-on-glass (SOG) mainly comprising silicon oxide and a yellow fluorescent material in a solvent, and thereafter firing the coated liquid. The fluorescent material film used in the present invention does not include any components rendering any colors other than yellow. Thus the luminous efficacy is improved, and at the same time, it is possible to make a light source apparatus with excellent moisture resistance, heat resistance, durability, and reliability.

Because of the advantages of improved moisture resistance and heat resistance, the light source apparatus equipped with the light conversion material mentioned above can be used in extreme situations, especially when used in high tropical temperatures, installed in equipment giving off an intense heat, employed in the market often exposed to water sprays, or employed while fishing, for example as a fishing lamp readily exposed to salt water. Furthermore, when the yellow fluorescent material mentioned above does not include yttrium, white light is obtained with further improved luminous efficacy by conversion.

### Second Embodiment

In a light conversion material of a light source apparatus according to a second embodiment of the invention, the metallic alkoxide has, as a metal element, at least one metal selected from a group consisting of silicon, titanium and zirconia. The light conversion material is the metallic alkoxide, which may be an oligomer, and may contribute to improvements in the heat resistance, moisture resistance, and durability of the fluorescent material film by forming a tight metal oxide thin film through coating, drying, and firing. To make the metal oxide film thin, the metallic alkoxide may be solved in a solvent, such as ethanol, methanol, acetone, isopropylene alcohol (IPA), ethylene glycol dimethyl ether, or propylene glycol dimethyl ether. Of those, spin-on-glass (SOG) may be used.

The SOG mentioned above is obtained by diluting the metallic alkoxide with a solvent. Therefore, the resultant fluorescent material film based on the SOG produces the same advantages of improved moisture resistance and heat resist as described above. The fluorescent material film mentioned above is easily formed by coating a curved inner wall surface or outer wall surface of the light source apparatus when the composition of the florescent material film is in a liquid form using the solvent.

### Third Embodiment

In a light source apparatus according to a third embodiment of the invention, the metallic oxide fine particles comprise of at least one oxide selected from a group consisting of silicon oxide, titanium oxide, aluminum oxide, or composite oxides thereof. With the above-mentioned composition, the viscosity of the dispersion is increased, and therefore, the dispersion for formation of the light conversion material is coated with uniform thickness, without precipitating the metallic oxide fine particles in the dispersion. The fluorescent material film containing the above-mentioned composition has a refractive index of 1.4 to 1.7, thereby improving the luminous efficacy when used for the light source apparatus.

### Fourth Embodiment

A light source apparatus according to a fourth embodiment of the invention comprises of at least a casing partially made of a translucent member, such as a glass substrate, a light conversion material capable of converting blue light emitted from a light emitting diode into a white light, a light emitting diode assembly, and a power connection unit provided in the casing. It also comprises of at least a fluorescent material film that may be formed by coating on at least one side of a glass substrate, a liquid mixture of fluorescent material, an organic binder, and a solvent, followed by drying and firing, and a thin film is further formed by coating, on the fluorescent material film, a coating material that contains a metallic alkoxide and/or metallic alkoxide oligomer, followed by drying and firing.

The fluorescent material film mentioned above can also be formed using a liquid prepared by dissolving the SOG, containing as the main component silicon oxide, and the yellow fluorescent material in a solvent, such as ethanol, methanol, acetone, isopropylene alcohol (IPA), ethylene glycol dimethyl ether, or propylene glycol dimethyl ether. The light emitting diode assembly in the casing is constructed in such a manner that at least one light emitting diode is provided on a substrate, which can be connected to a power supply unit.

The above-mentioned power connection unit, provided in the casing is electrically connected to the light emitting diode assembly. When the power connection unit is connected to an alternating-current power supply, the unit is equipped with a power converter in the casing to supply the desired power to the light-emitting diode after converting to the required voltage and current. When the power connection unit is connected to a direct current power supply, the unit is connected to a power supply circuit or the like capable of supplying a voltage and a current necessary for the light-emitting diode.

The shape of the casing is not particularly limited. This means that the translucent member may have a flat surface and/or a curved surface. Regardless of whether the surface of the translucent member may be a flat or curved inner or outer wall, the fluorescent material film and the thin film with a uniform thickness can be formed on the translucent member of the casing. Coating of the dispersion for formation of the fluorescent material film may be carried out using a spin coater or the like, to make the thickness of the coated layer uniform. After the above-mentioned dispersion is coated, the dispersion is subjected to firing in an atmosphere of an inert gas such as nitrogen gas, hydrogen gas, a gas mixture of nitrogen gas and hydrogen gas (forming gas), or the like to eliminate the solvent and deposit the composition of an oxide comprising of silicon oxide as the main component and a fluorescent material. The silicon oxide-based oxide composition containing the fluorescent material is excellent in the moisture and heat resistance, increasing the demand in many fields.

### Fifth Embodiment

In contrast to the fourth embodiment of the invention where the shape of the casing is not particularly specified, a light source apparatus according to a fifth embodiment of the invention has a translucent member (glass material) shaped into a light bulb, for the purpose of replacing conventional light bulbs. The fluorescent material film and the light emitting diode assembly in the fifth embodiment may be substantially the same as those in the fourth embodiment. The fluorescent material film is coated on the inner wall and/or outer wall of the light bulb-shaped translucent member. The light emitting diode assembly is installed in the light bulb-shaped translucent member. A socket portion is attached to the bottom of the light bulb-shaped translucent member, and the light bulb-shaped translucent member is connected to an electric conduction screw portion of the socket portion via the light emitting diode assembly and a power supply unit.

The power supply unit is a unit capable of converting the commercial power (AC 100 V) into a predetermined voltage and current, for example, according to the number of light emitting diodes in the above-mentioned light emitting diode assembly. The electric conduction screw portion of the socket portion in the light source apparatus of the fifth embodiment of the invention is the same as that in the incandescent lamp, so that the light source apparatus and the incandescent lamp are interchangeable. In addition to the above, illumination with improved luminous efficacy and outstanding moisture and heat resistance is obtained.

### Sixth Embodiment

In the light source apparatus according to a sixth embodiment of the invention, the light emitting diode assembly is suspended by a column made of, for example, an aluminum or anodized aluminum member in the casing or the light bulb-shaped translucent member. The aluminum member or the like as mentioned above shows good electrical conduction and heat transfer, so that thermal dissipation is satisfactory. When the column with satisfactory thermal dissipation is connected to the power line via the socket portion, heat generated from the light emitting diode can be dissipated into the power line, thereby improving the efficiency of heat dissipation.

### Seventh Embodiment

The fluorescent material film in the light source apparatus according to a seventh embodiment of the invention is formed by coating the above-mentioned solution, so that the thickness of the film can be adjusted to 20 to 200 micrometers. The fluorescent material film is formed by subjecting the coated liquid to firing at 100 to 500° C. for 10 to 60 minutes. Thus, the resultant fluorescent material film produces satisfactory results by not showing any change in the quality of film after the tests of 60° C. and 90% RH for 1,000 hours and 85° C. and 85% RH for 1,000 hours, or the pressure cooker test (PCT) of 121° C. and 2 atom for 96 hours. The fluorescent material film is highly resistant to elevated temperatures. Further, the fluorescent material film was not susceptible to high temperatures, such as 1,000° C., after the firing step. Not only is the fluorescent material film thin and uniform, but also the durability of the layer is improved with minimum age deterioration. These results are provided by spraying or coating a coating liquid where a fluorescent material is dissolved in a solvent, and thereafter subjecting the coated liquid to firing.

### Eighth Embodiment

The socket portion of the light source apparatus according to an eighth embodiment of the invention, which is provided at the bottom of the bulb-shaped glass substrate, includes an electric conduction screw portion to screw into lighting fixture and a heat dissipation part. The above-mentioned heat dissipation part exhibits a good design as well as excellent heat dissipation properties for the light source apparatus when a concavo-convex portion is formed on the heat dissipation part similarly to the electric conduction screw portion.

### Ninth Embodiment

In the light source apparatus according to a ninth embodiment of the invention, the glass material is a lens having a convex and/or concave surface. The lens mentioned above may be attached to the top of a small-sized light source apparatus such as a flashlight or the like to emit a more intense light.

### Example 1

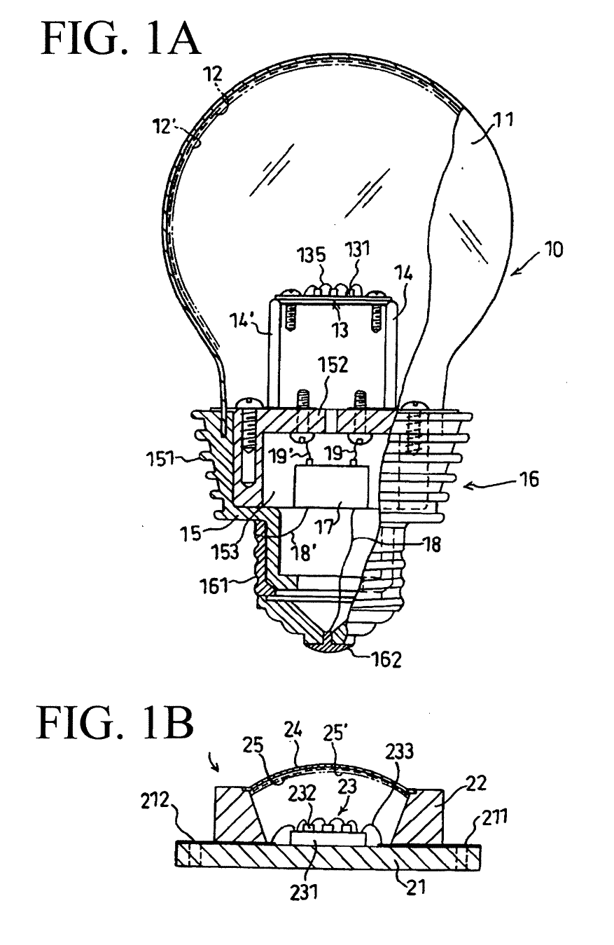

FIG. 1A is an explanatory cross sectional view of a light source apparatus, which includes an electric bulb-like translucent member according to the present invention. FIG. 1B is an explanatory cross sectional view of a light source apparatus having a reflection frame. In FIG. 1A, an electric bulb (light source apparatus) 10 is made up of an outer bulb (electric bulb-like translucent material) 11 and a socket section 16 to which the electric bulb-like translucent material 11 is attached. The socket section 16 is made up of at least a heat release portion 15, which has a filler (concavo-convex portion) 151, and an electric conduction screw portion 161 with which the heat release portion 15 is continuously and integrally formed. The electric bulb-like translucent material 11 is made from, for example, glass base material, and the fluorescent material film 12 is applied to the inner wall surface thereof. Moreover, while the heat release portion 15 has the concavo-convex portion 151 in the outside, and a heat sink (attachment substrate) 152 is formed thereinside, and a heat release portion (space section) 153 is formed in a lower part thereof. Above the attachment substrate 152, the substrate (light emitting diode assembly object) 13 is held by the conductive support 14 and 14′.

The fluorescent material film 12 is formed at the rear surface of the glass made outer bubble 11 and is facing toward the substrate 13 whereto many LEDs 131 are attached by wire bonding in series and/or in parallel.

The fluorescent material film 12 is formed, at the rear surface of the outer bubble 11, by coating a liquid mixture of fluorescent material, an organic binder, and a solvent, followed by drying and firing so that the organic binder is substantially removed. The organic binder used here may be at least one or more resin or resins selected from a group consisting of a cellulose group including methyl cellulose, etylcellulose, hydroxyethyl cellulose, a polyvinyl alcohol group resin, alkyd group resin, btyral group resin, phenol group resin, and rosin group resin. Other organic material may be used if it achieves uniform coating and may be burned by firing.

An inorganic binder may be used or mixed so as to increase the tightness of the fluorescent material's attachment to the glass material. The use of inorganic fine particles, such as silica fine particles, alumina fine particles, and titania fine particles, is preferred.

Examples of the fluorescent materials include well-known yellow fluorescent materials, such as silicate group fluorescent material, YAG group fluorescent material, and TAG group fluorescent material. As to a blue LED, the yellow fluorescent may be used, and, if color rendering properties are desired, red fluorescent material may be mixed. Use of ultraviolet LED together with RGB three color fluorescent materials may increase luminescence efficiency.

Further, on the fluorescent material film, a thin film 12′ is formed by coating a coating material that contains a metallic alkoxide and/or metallic alkoxide oligomer, followed by drying and firing.

The above-mentioned metallic alkoxide is a metallic alkoxide represented by the following formula (I) and/or an oligomer thereof:

M(OR)ₙR′₄₋ₙ (I)

wherein n is an integer of 1 to 4, R and R′ indicate an alkyl group having 1 to 4 carbon atoms, and M is an early transition metal such as Si, Ti, Zr or the like. Specific examples of the above-mentioned metallic alkoxide include silicon alkoxides, such as tetramethoxy silane, tetraethoxy silane, tetrapropoxy silane, tetraisopropoxy silane, tetrabutoxy silane, vinyltriethoxy silane, methyl trimethoxy silane, methyl triethoxy silane, and the like; titanium alkoxides, such as titanium tetramethoxide, titanium tetraethoxide, and the like; and zirconia alkoxides, such as zirconia tetrapropoxide, zirconia tetraisopropoxide, zirconia tetrabutoxide, and the like. They may be used alone or in combination. In particular, silicon alkoxides are preferred among the above-mentioned metallic alkoxides.

Further, adherence of the fluorescent material and the metallic alkoxide may be increased by adding silane coupling agent. Examples of the silane coupling agents include silane coupling agents having amino-group terminal, such as γ-glycidoxy propyl-tri-methoxy silane, γ-glycidoxy propyl trietoxy silane, β-(3,4 epoxy cyclohexyl)ethyl trimethoxy silane, ethyltrimethoxysilane and γ-aminopropyl triethoxy silane. Amount to be mixed is about 0.1-1 percent by mass.

A lighting circuit (power supply portion) 17, which converts AC 100 V into voltage and current suitable for the light emitting diode chip 131, is provided on the space section 153. An electric conduction end portion 162, which is insulated, is provided at an end portion of the electric conduction screw portion 161 of the socket section 16. The current of AC 100 V flows through in the following order: the electric conduction end portion 162, a lead wire (copper wire) 18, the power supply section 17, a lead wire 19, the conductive support 14, the light emitting diode (light emitting diode chip) 131, a lead wire (bonding wire) 135, the conductive support 14′, a lead-wire (copper wire) 19′, the power supply section 17, a lead-wire (copper wire) 18′, and a mouthpiece (conductive screw portion) 161. Blue light emitted from the light emitting diode chip 131 is converted into white light, which is excellent in the luminous efficacy due to the fluorescent material film 12.

In FIG. 1B, a surface mount type light emitting diode (light source apparatus) 20 is made up of at least an attachment substrate 21, a reflective frame 22, a light emitting diode assembly 23, and a translucent material 24. While electrodes 211 and 212 are formed, for example, at both ends and on a top face of the attachment substrate 21, the reflective frame 22 is attached on the attachment substrate 21. The light emitting diode assembly 23 is provided at the center of the reflective frame 22 on the attachment substrate 21. A resin mold (translucent material) 24, on an inner wall surface of which the fluorescent material film 25 is formed, is provided in an opening of the reflective frame 22. The shape of the casing, which is made up of the attachment substrate 21, the reflective frame 22, and the translucent material 24, may be changed according to use thereof. Moreover, a reflective member is provided on an inner face of the reflective frame 22.

The fluorescent material film 12 or 25 for use in the present invention will now be explained. As the fluorescent material film 12 or 25, spin-on-glass (SOG) which is used for semiconductor insulating film. The SOG may be dissolved in a solvent such as ethanol, methanol, acetone, isopropylene alcohol (IPA), ethylene glycol dimethyl ether, or propylene glycol dimethyl ether.

For example, using a spin coater or the like, the dispersion prepared by dispersing the above-mentioned composition or the solution prepared by dissolving the above-mentioned composition is coated to form a layer with a uniform thickness, for example, on an inner wall of the light source apparatus.

The fluorescent material-containing dispersion coated on the bulb-shaped translucent member 11 or the translucent member 24 is subjected to firing at 300° C. Thus, the resultant fluorescent material film 12 or 25 produced satisfactory results and showed no change in its layer quality after the tests of 60° C. and 90% RH for 1,000 hours and 85° C. and 85% RH for 1,000 hours, or the pressure cooker test (PCT) of 121° C. and 2 atom for 96 hours. After firing, the fluorescent material film 12 or 25 became highly resistant to high temperatures and showed no change at 1,000° C. It was possible to make the tight fluorescent material film 12 or 25 a solid layer of high durability as well as a layer with a uniform thickness because the firing was carried out after coating of the coating material of the metal alkoxide, in particular, of silicon alkoxide group.

The thus sprayed or coated fluorescent material film in a liquid form is subjected to firing in an atmosphere of an inert gas such as nitrogen gas, hydrogen gas, a gas mixture of nitrogen gas and hydrogen gas (forming gas), or the like to eliminate the solvent and deposit an oxide composition containing silicon oxide as the main component and the fluorescent material. The silicon oxide-based composition containing the fluorescent material is excellent in the luminous efficacy, moisture resistance, heat resistance, durability, and reliability, thereby increasing the demand in many fields. In addition, the fluorescent material film can be formed uniformly on the flat surface or curved surface because formation of the fluorescent material film is achieved by spraying or coating.

In the above-mentioned composition for constituting the fluorescent material film formed by firing the metallic alkoxide of at least one metal selected from a group consisting of silicon, titanium, and zirconia. As a result, the resultant fluorescent material film of about 0.1 μM to 10 μm shows improved heat resistance and durability and a refractive index ranging from 1.4 to 1.7, thereby improving the luminous efficacy when used for the light source apparatus.

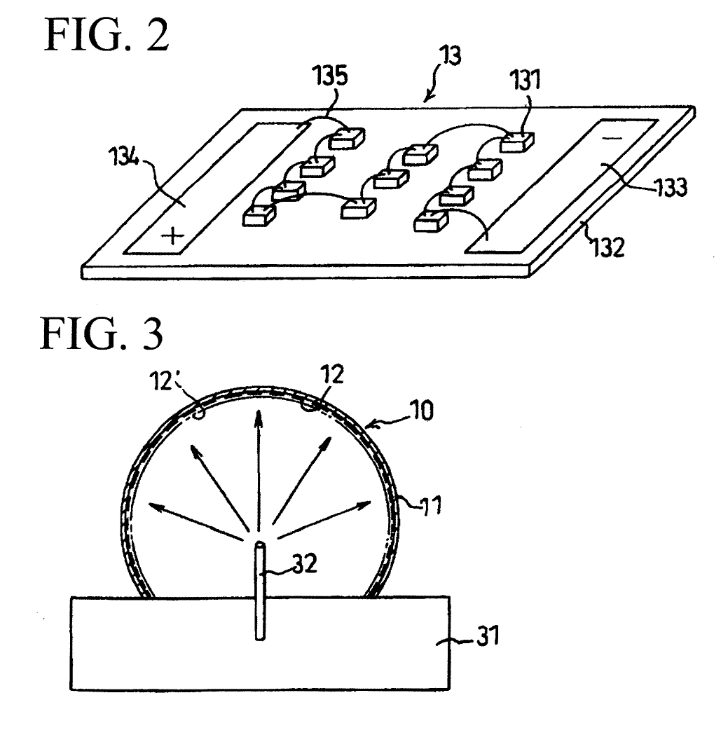

FIG. 2 is a diagram for explaining a light emitting diode assembly according to an embodiment of the present invention. In FIG. 2, the light emitting diode assembly 13 comprises, for example, a ceramic substrate 132, two or more light emitting diode chips 131 attached to the ceramic substrate 132, electrodes 133 and 134, and bonding wires 135 for respectively connecting the light emitting diode chips 131 and the electrodes. The attachment of each blue light-emitting diode chip 131 to the ceramic substrate 132 or wire bonding therefor, on the light emitting diode light diode assembly 13 can be performed by the known or well known technology.

FIG. 3 is a diagram for explaining a method of forming a fluorescent material film on an inner wall surface of a spherical surface, according to an embodiment of the present invention. In FIG. 3, an electric bulb-like translucent material 11, which has the spherical surface, is held by a jig 31. Moreover, dispersion liquid in which fluorescent material etc. according to the present invention is dispersed is applied by spraying it toward the inner wall surface of the electric bulb-like translucent material 11 in all directions from a nozzle 32. Furthermore, it is possible to make the thickness thereof more uniform by rotating either the electric bulb-like translucent material 11 or the jig 31. Then, the fluorescent material serves as the precise fluorescent material film 12 with uniform thickness by calcinating it in inert gas and removing a solvent.

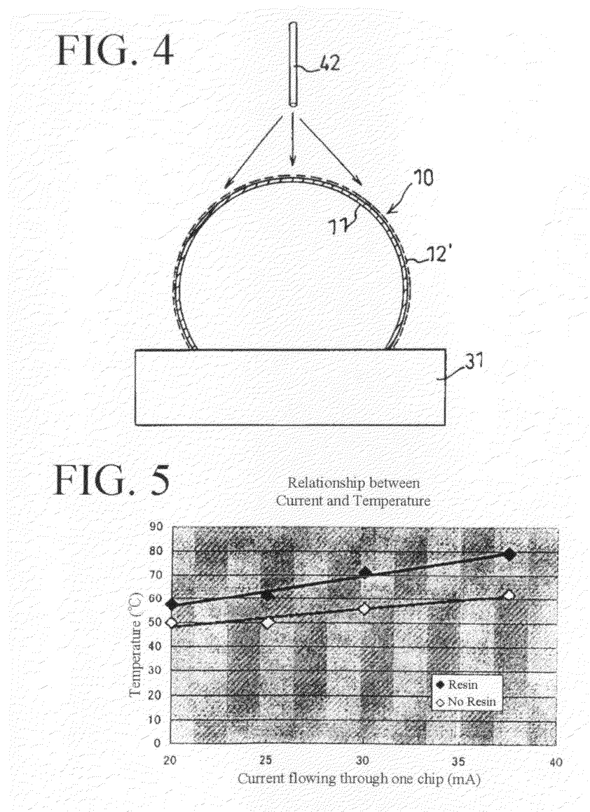

FIG. 4 is a diagram for explaining a method of forming a fluorescent material film on an outer wall face having a spherical surface according to another embodiment of the present invention. In FIG. 4, the electric bulb-like translucent material 11, which has the spherical surface, is fixed to the jig 31. Moreover, the liquid containing the fluorescent material of the present invention is applied by spraying it towards the outer wall face of the electric bulb-like translucent material 11 from a nozzle 42 provided outside the electric bulb-like translucent material 11.

In the application and calcination in FIGS. 3 and 4, it is possible to rotate the electric bulb-like translucent material 11 and/or the jig 31, or the nozzle 32 or 42. It is possible to make the thickness of the fluorescent material film more uniform by rotating one or both of them. Then, the fluorescent material becomes the precise fluorescent material films 12 and 12′ by calcinating it in inert gas and removing the solvent.

FIG. 5 is a diagram for explaining the effect due to the existence of covered resin according to an embodiment, comparing an example of the prior art, which does not have covered resin. In FIG. 5, a phrase “no resin” is based on the embodiment of the present invention, and as shown in FIG. 3 or 4, the fluorescent material film is formed on the inner wall surface or the outer wall surface of the electric bulb-like translucent material 11, wherein particles of the phosphor are not covered with resin. In FIG. 5, a phrase “resin” means that particles of the phosphor (not shown) are covered and protected with resin. As apparent from FIG. 5, when the particles of the phosphor are not covered with resin (the present embodiment), the temperature to current (mA) flowing through one light emitting diode chip is low. The fluorescent material film is also the same as each other when the particles of the phosphor are covered with resin and when the fluorescent material film is covered with resin.

Moreover, as apparent from FIG. 5, when the fluorescent material films 12 and 12′ are not covered with resin (the present embodiment), the difference of the temperatures increases as the current passing through one light emitting diode chip increases. That is, even if a large current flows through the light emitting diode chip, since the temperature rise thereof is small, the luminous efficacy, moisture resistance, heat resistance, and durability of the fluorescent material films 12 and 12′ according to this embodiment are improved.

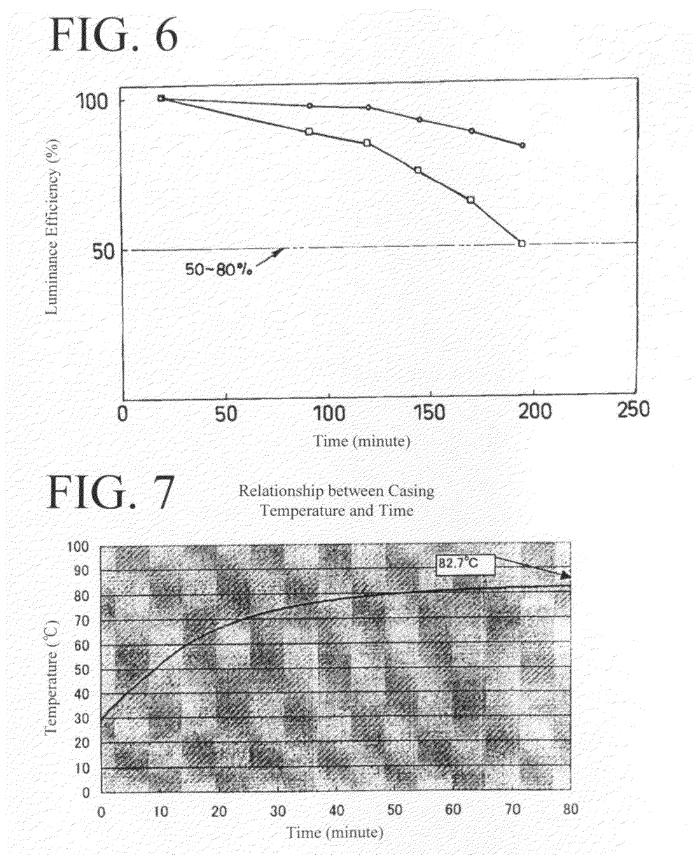

FIG. 6 shows a graph showing the transition of the temperature and luminous efficacy due to the fluorescent material film according to the present invention and the prior art. In FIG. 6, a polygonal line in an upper side shows the present invention and in a lower side shows the prior art. In the light source apparatus in which the fluorescent material film of the present invention is formed, the decrease of the luminous efficacy is small, even if the temperature thereof rises. On the other hand, in the light source apparatus in which the fluorescent material film of the prior art is formed, it turns out that the luminous efficacy thereof decreases rapidly according to a rise of the temperature. Especially, in the light emission apparatus in which the fluorescent material film of the prior art is formed, the luminous efficacy thereof decreases to approximately half the value at 200 degrees Celsius.

FIG. 7 is a graph showing the relationship between time and temperature in the light source apparatus that uses the fluorescent material film according to the present invention. FIG. 7 shows an example in a light source apparatus with eleven (11) chips, of current of 210 mA and 450 mW, which is equivalent to 40 W of an incandescent lamp. It turns out that in the example of the light source apparatus, a temperature rise becomes constant in approximately one (1) hour.

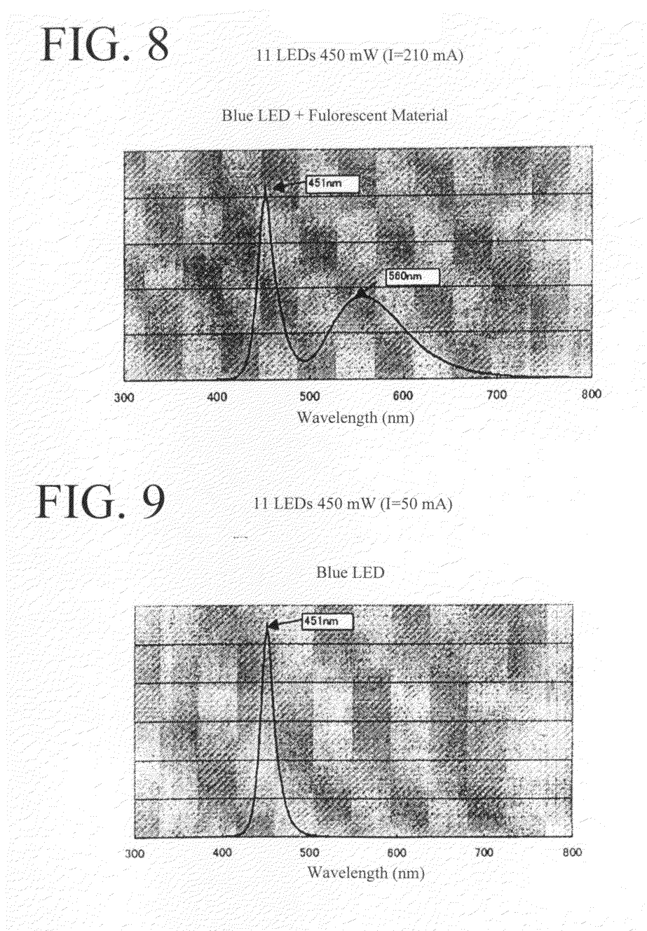

FIG. 8 is a graph for explaining a peak of wavelength in the light source apparatus that uses the fluorescent material film according to the present invention. FIG. 9 is a graph for explaining a peak of the wavelength in the light source apparatus that uses the fluorescent material film of the prior art. In FIG. 8, the fluorescent material film made from the composite of the present invention has peaks of wavelengths at 451 nm and 560 nm. In FIG. 9, the fluorescent material film of the prior art has a peak at 451 nm. When FIGS. 8 and 9 are compared with each other, since the fluorescent material film according to the present invention has the peaks of wavelengths at 451 nm and 560 nm, it serves as white light with high luminous efficacy.

Although the embodiments of the present invention are explained above in full detail, the present invention is not limited to these embodiments. It is possible to make various changes to the design of the present invention, as long as it does not deviate from the claimed invention. For example, the light emitting diode may be an upper and lower electrode type light emitting diode. The well-known package can be used for the light emitting diode assembly. Moreover, in addition to an electric bulb shape, the shape of the casing on which the fluorescent material film of the present invention is formed may be any shape.

The preceding description has been presented only to illustrate and describe exemplary embodiments of the present light source apparatus. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A light source apparatus comprising:
a light emitting diode; and
a fluorescent material film capable of converting ultraviolet or blue light emitted from the light emitting diode into white light,
wherein the fluorescent material film is formed by coating, on at least one side of a glass substrate, a liquid mixture of fluorescent material, an organic binder, and a solvent, followed by drying and firing, and a thin film is further formed by coating, on the fluorescent material film, a coating material that contains a metallic alkoxide, metallic alkoxide oligomer, or both metallic alkoxide and alkoxide oligomer, followed by drying and firing.

2. The light source apparatus according to claim 1, wherein the metallic alkoxide has, as a metal element, at least one metal selected from a group consisting of silicon, titanium, and zirconia.

3. The light source apparatus according to claim 1, wherein the organic binder is at least one binderselected from a group consisting of a cellulose group including methyl cellulose, etylcellulose, hydroxyethyl cellulose, a polyvinyl alcohol group resin, alkyd group resin, btyral group resin, phenol group resin, and rosin group resin.

4. The light source apparatus according to claim 2, wherein the organic binder is at least one binder selected from a group consisting of a cellulose group including methyl cellulose, etylcellulose, hydroxyethyl cellulose, a polyvinyl alcohol group resin, alkyd group resin, btyral group resin, phenol group resin, and rosin group resin.

5. A light source apparatus comprising:
a casing that is at least partially made of a glass substrate;
a light emitting diode assembly, attached to inside of the casing;
a fluorescent material film, which is formed by coating on at least one side of a glass substrate, a liquid mixture of fluorescent material, an organic binder and a solvent, followed by drying and firing, and a thin film is further formed by coating, on the fluorescent material film, a coating material that contains a metallic alkoxide and/or metallic alkoxide oligomer, followed by drying and firing, and a power connection unit that is electrically connected to the light emitting diode assembly and that is provided on the casing.

6. A light source apparatus comprising:
a casing that is at least partially made of a glass substrate in a light bulb shape;
a light emitting diode assembly, attached to the inside of the casing;
a fluorescent material film, which is formed by coating on at least one side of a glass substrate, a liquid mixture of fluorescent material, an organic binder and a solvent, followed by drying and firing, and a thin film is further formed by coating, on the fluorescent material film, a coating material that contains a metallic alkoxide and/or metallic alkoxide oligomer, followed by drying and firing;
a power supply unit that supplies electric power to the light emitting diode assembly; and
a socket that is electrically connected to the power supply unit.

7. The light source apparatus according to claim 5, wherein the light emitting diode assembly is suspended in the casing or the light bulb-shaped translucent member by a member having electrical conduction and heat transfer.

8. The light source apparatus according to claim 6, wherein the light emitting diode assembly is suspended in the casing or the light bulb-shaped translucent member by a member having electrical conduction and heat transfer.

9. The light source apparatus according to claim 5, wherein a thickness of the film is 20 to 200 μm.

10. The light source apparatus according to claim 6, wherein a thickness of the film is 20 to 200 μm.

11. The light source apparatus according to claim 7, wherein a thickness of the film is 20 to 200 μm.

12. The light source apparatus according to claim 8, wherein a thickness of the film is 20 to 200 μm.

13. The light source apparatus according to claim 6, wherein the socket portion includes an electric conduction screw portion that is screwed in a lighting fixture and a heat dissipation part.

14. The light source apparatus according to claim 1, wherein the glass substrate is a lens having a convex, concave, or both convex and concave surface.
